(19) United States
(12) Patent Application Publication
(10) Pub. No.: US 2002/0046475 A1
(43) Pub. Date: Apr. 25, 2002

(54) Drying process with vortex tube

(75) Inventors: Young I. Cho, Cherry Hill, NJ (US); Cheolho Bai, Taegu (KR)

Correspondence Address: OSTROLENK, FABER, GERB & SOFFEN, LLP, 1180 Avenue of the Americas, New York, NY, 10036-8403, US

(73) Assignee: Vortex Aircon

(21) Appl. No.: 09/935,979

(22) Filed: Aug. 23, 2001

Related U.S. Application Data
(60) Provisional application No. 60/227,185, filed on Aug. 23, 2000.

(51) Int. Cl. F26B 19/00; F26B 25/06; F26B 3/00

(52) U.S. Cl. 34/443; 34/219; 34/224

(57) ABSTRACT

A drying structure and process has a wet or damp mass to be dried in a container. Hot dry gas is fed into the container to flow over and/or through the mass to be dried, and the vapor-containing gas which is produced by contact with the mass is discharged from the container to the input of a vortex tube. The vortex tube separates the humid vapor into a liquid which may be discharged, and a dried gas which is recirculated back to the container for further drying of the mass.

### RELATED APPLICATIONS

This application claims the benefit of U.S. Provisional Application No. 60/227,185, filed Aug. 23, 2000.

### FIELD OF THE INVENTION

This invention relates to drying apparatus and a novel drying process and more specifically relates to an improved drying process employing a vortex tube for recovering and recirculating hot dry gas such as air from the hot humid or vapor laden gas output of the dryer.

### BACKGROUND OF THE INVENTION

Drying processes are widely used in numerous industries including, but not limited to cement, food, paper/pulp, chemical textiles, laundry and the like. It has been estimated that drying consumes 30% of the total energy used in industrial countries.

The drying process usually forces or otherwise applies a hot dry air flow to the wet substance to be dried, so that moisture is absorbed and discharged as hot humid air. This hot, humid discharge contains substantial heat energy. However, since it is almost always a saturated vapor, it is not useful for a further drying purpose. Thus, it is discharged to the atmosphere, wasting large amounts of energy.

### BRIEF DESCRIPTION OF THE INVENTION

In accordance with the invention, the hot humid discharge air or gas, or vapor in a drying process is applied to the input of a vortex tube which is operable to separate liquid from gas and vapor in the input stream. Such vortex tubes are described, for example, in copending application Ser. No. 60/227,144, filed Aug. 23, 2001 entitled VORTEX TECHNOLOGY FOR LOW PRESSURE in the names of Cho and Bai, the disclosure of which is incorporated herein by reference. The output gas/vapor of the vortex tube is a hot dry air which is recirculated to the input of the mass to be dried. Thus, a substantial amount of the formerly wasted energy is reused in the drying operation.

### BRIEF DESCRIPTION OF THE DRAWINGS

FIG. 1 schematically illustrates a conventional drying operation.

FIG. 2 schematically illustrates the present invention.

### DETAILED DESCRIPTION OF THE DRAWINGS

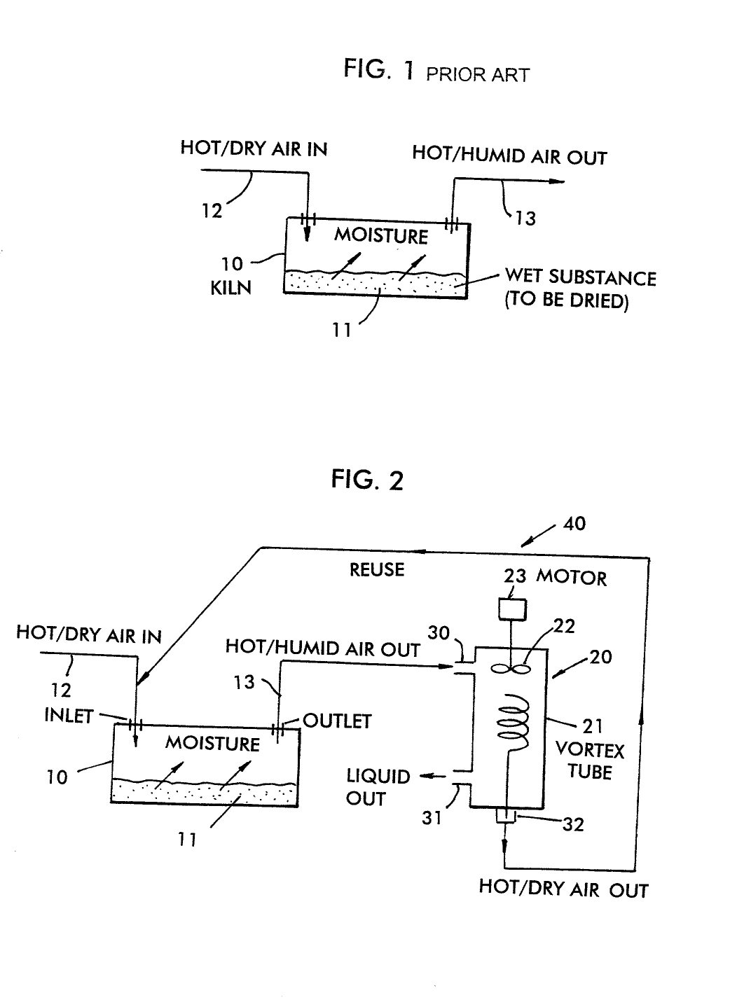

Referring first to FIG. 1, there is shown a kiln or container 10 filled with any substance 11 which may be a liquid impregnated or liquid containing mass or pulp to be dried. A source of hot, dry air is connected to tube 12, which is connected to container 10 and is arranged to cause the hot, dry air (or other gas) to flow through and/or across wet substance 11. The hot, dry air will pick up moisture to dry the substance 11 as desired and is discharged at discharge line 13 as hot, humid air. Since the hot, humid air is a saturated vapor, it has not been reused in the past, but is generally discharged to the atmosphere and its energy content is wasted.

In accordance with the invention, a vortex tube 20 shown in FIG. 2 is added to the system of FIG. 1 to recover energy from the hot, humid air discharge 13 to allow the reuse of this recovered energy in the drying process.

Thus, vortex tube 20 has a vortex body 21 containing a propeller 22 rotated by motor 23, for example, at 3000 RPM, to create a vortex flow along the length of body 21 in conventional fashion. Vortex body 21 has an inlet 30 connected to discharge line 13 of container 10, a liquid outlet 31, and a gas outlet 32.

Hot, humid air discharged from container 10 travels through discharge line 13 and enters the top of vortex tube 20 through inlet 30. The hot, humid air is caused to spiral downward, with liquid being forced radially outward to the interior wall of tube 21 and downward to liquid outlet 31. The remaining hot, dry air will exit the vortex tube at gas outlet 32. This hot, dry air (or dry air plus vapor) from outlet 32 is then recycled, over line 40 to the input of container 10, along with the hot dry air from source pipe 12. A suitable pump may be used to pump hot, dry air to container 10.

Thus, in accordance with the invention, a substantial portion of the energy in humid discharge air is recovered and reused in the drying process.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. In a drying apparatus;
a container for containing a liquid containing mass which is to be dried by the removal of at least a portion of the liquid therefrom;
said container having at least one relatively hot dry gas inlet and at least one relatively humid gas outlet removed from said inlet to direct the flow of dry gas from said inlet to interact with and absorb liquid from said mass to be dried and to exit through said humid gas outlet;
the improvement which comprises a vortex tube having an inlet connected to said humid gas outlet and having a hot dry gas outlet and a liquid outlet;
said hot gas outlet being connected to at least one inlet in said container for circulating the hot dry gas recovered from said humid vapor outlet into said container and back through the mass to be dried.

2. The apparatus of claim 1, wherein said gas is air, and whereby said fluid is water.

3. The apparatus of claim 1, wherein said container is sealed.

4. A drying apparatus of drying a wet mass;
said drying apparatus comprising a container for receiving the wet mass;
a source of drying air which can absorb moisture from the wet mass when contacting said wet mass;
an outlet in said container for removing vapor laden drying air after it has contacted the mass to be dried;
a vortex tube which has a vapor laden air inlet and, a gas outlet and a liquid outlet whereby vapor laden air applied to said vapor inlet is at least partially separated into a dried gas and a liquid which are applied to said gas outlet and liquid outlet respectively;
and a re-circulation structure connecting said gas outlet to said container.

5. The process of drying a liquid impregnated mass comprising the application of a hot drying gas into contact with said mass to absorb liquid therefrom to produce a humid gas vapor;
applying said humid gas vapor to a gas-liquid separator to remove liquid from said humid gas vapor to recover a hot dry gas from said vapor; and
discharging the liquid recovered from said vapor; and
recirculating the gas recovered from said gas-liquid separator back to recontact said mass to used said recirculated gas to further dry said mass.
